(19) United States
(12) Patent Application Publication
(10) Pub. No.: US 2025/0183950 A1
(43) Pub. Date: Jun. 5, 2025

(54) DOPPLER CHANNEL STATE INFORMATION (CSI) BASED ON A MODIFIED SLEPIAN BASIS

(71) Applicant: QUALCOMM Incorporated, San Diego, CA (US)

(72) Inventors: Jing Dai, Beijing (CN); Wei Xi, Beijing (CN); Min Huang, Beijing (CN); Liangming Wu, Beijing (CN)

(21) Appl. No.: 18/842,069

(22) PCT Filed: Apr. 29, 2022
(86) PCT No.: PCT/CN2022/090326

§ 371 Date: Aug. 28, 2024

(51) Int. Cl. H04B 7/0456; H04B 7/06; H04L 5/00

(52) U.S. Cl. CPC H04B 7/0456; H04B 7/0626; H04L 5/0048

(57) ABSTRACT

Techniques related to channel measurement and precoding are disclosed. Some aspects of the disclosure relate to devices and methods for receiving a reference signal and generating a phase shift value v_{Dshift} associated with a group of modified Slepian bases based on the reference signal. A channel measurement report sends the phase shift value v_{Dshift} to a network node. The network node employs the phase shift value v_{Dshift} for shifting a phase of Doppler basis as a time domain basis in a precoder for precoding a downlink transmission. Other aspects, embodiments, and features are also claimed and described.

### TECHNICAL FIELD

The technology discussed below relates generally to wireless communication systems, and more particularly, to wireless channel measurement and reporting. Certain aspects may relate to techniques for enabling and providing communication devices configured to communicate using a modified Slepian basis as a time domain basis for a precoder.

### INTRODUCTION

In wireless communication systems, the use of multiple antennas at a transmitter and/or at a receiver can provide improved functionality beyond the use of a single antenna at each endpoint. For example, beamforming, or the directional transmission or reception of a wireless signal, can be achieved by applying a suitable precoding matrix to a signal transmission. That is, the amplitude and phase of each antenna in an array of antennas may be precoded, or controlled to create a desired (e.g., directional) pattern of constructive and destructive interference in the wavefront. In another example, sometimes referred to as spatial multiplexing or multiple-input multiple-output (MIMO), a transmitter can transmit multiple different streams of data, also referred to as layers, simultaneously on the same wireless resources. Similar to beamforming, for MIMO, the transmitter applies a suitable beamforming matrix to a signal transmission.

For beamforming and for MIMO, generation of a suitable precoding matrix generally corresponds to sophisticated processing of a timely channel estimate, where a reference signal transmitted over the channel is received and measured. However, performance of these systems can suffer when a mobile device travels at a high speed. That is, when the characteristics of the channel between a mobile device and a base station are rapidly changing, a channel estimate ages quickly and a precoding matrix generated based on a given channel estimate quickly becomes less precise. Those in the field are continuously seeking improvements to mobile device channel reporting capabilities and addressing issues like channel aging.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

In one example, an apparatus for wireless communication is disclosed. The apparatus includes a memory and a processor coupled to the memory. The processor is configured to receive, via a transceiver coupled to the processor, a reference signal. The processor is further configured to transmit a phase shift value v_{Dshift} based on the reference signal, the phase shift value v_{Dshift} being associated with a group of modified Slepian bases. The processor is further configured to receive a downlink transmission precoded based on a modified Slepian basis as a time domain basis.

In another example, an apparatus for wireless communication is disclosed. The apparatus includes a memory and a processor coupled to the memory. The processor is configured to receive a phase shift value v_{Dshift} associated with a group of modified Slepian bases. The processor is further configured to cause transmission of a downlink transmission precoded based on a modified Slepian basis as a time domain basis.

In another example, an apparatus for wireless communication is disclosed. The apparatus includes a memory and a processor coupled to the memory. The processor is configured to receive an uplink reference signal and transmit a downlink transmission precoded based on a modified Slepian basis as a time domain basis. Here, the modified Slepian basis is configured with a phase shift v_{Dshift} determined based on the uplink reference signal.

In another example, a method for wireless communication is disclosed. The method includes receiving a reference signal and transmitting a phase shift value v_{Dshift} based on the reference signal. Here, the phase shift value v_{Dshift} is associated with a group of modified Slepian bases. The method further includes receiving a downlink transmission precoded based on a modified Slepian basis as a time domain basis.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a schematic illustration of an example of a disaggregated base station architecture according to some aspects of this disclosure.

FIG. 4 is a schematic illustration of an organization of wireless resources in an air interface utilizing orthogonal frequency divisional multiplexing (OFDM) according to some aspects of this disclosure.

FIG. 5 is a block diagram illustrating a wireless communication system supporting multiple-input multiple-output (MIMO) communication according to some aspects of this disclosure.

FIG. 6 is a schematic illustration of channel state information (CSI) extrapolation as it may be performed according to some aspects of this disclosure.

FIG. 7 is a call flow diagram illustrating a process for channel measurement and reporting according to some aspects of this disclosure.

FIG. 8 is a flow chart illustrating an exemplary process for channel measurement and reporting according to some aspects of this disclosure.

FIG. 9 is a call flow diagram illustrating another process for channel measurement and reporting according to some aspects of this disclosure.

FIG. 10 is a flow chart illustrating an exemplary process for channel measurement and reporting according to some aspects of this disclosure.

FIG. 11 is a block diagram conceptually illustrating an example of a hardware implementation for a network node according to some aspects of this disclosure.

FIG. 12 is a block diagram conceptually illustrating an example of a hardware implementation for a user equipment (UE) according to some aspects of this disclosure.

### DETAILED DESCRIPTION

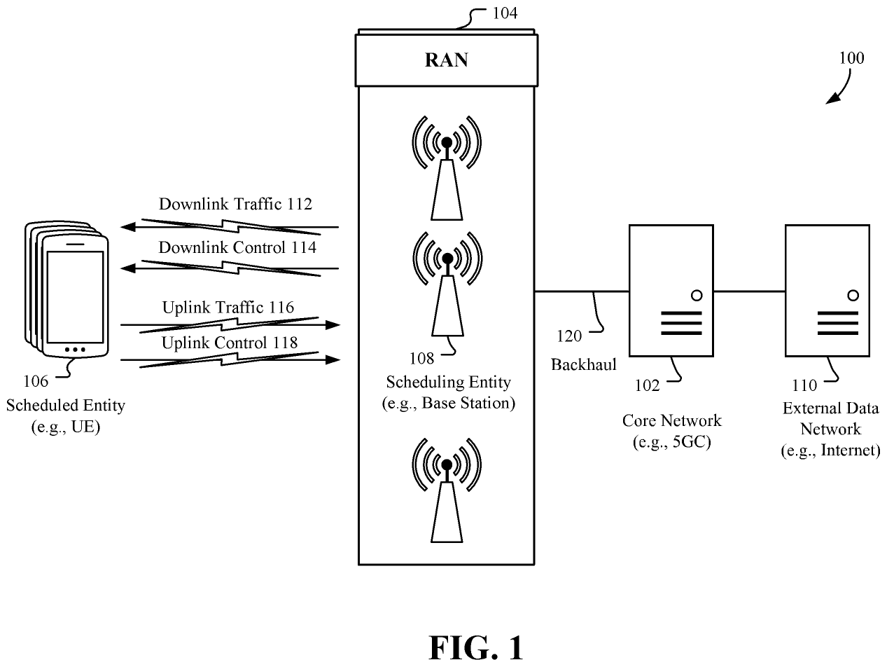

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

The radio access network (RAN) 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., network node 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a network node 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by a scheduling entity 108.

Base stations are not the only entities that may function as scheduling entities. That is, in some examples, a UE or network node may function as a scheduling entity, scheduling resources for one or more scheduled entities (e.g., one or more UEs).

As illustrated in FIG. 1, a network node 108 may broadcast downlink traffic 112 to one or more UEs 106. Broadly, the network node 108 is a node or device responsible for scheduling traffic in a wireless communication network, including downlink traffic 112 and, in some examples, uplink traffic 116 from one or more UEs 106 to the network node 108. On the other hand, the UE 106 is a node or device that receives downlink control information 114, including but not limited to scheduling information (e.g., a grant), synchronization or timing information, or other control information from another entity in the wireless communication network such as the network node 108.

In general, network nodes 108 may include a backhaul interface for communication with a backhaul portion 120 of the wireless communication system. The backhaul 120 may provide a link between a network node 108 and the core network 102. Further, in some examples, a backhaul network may provide interconnection between the respective network nodes 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

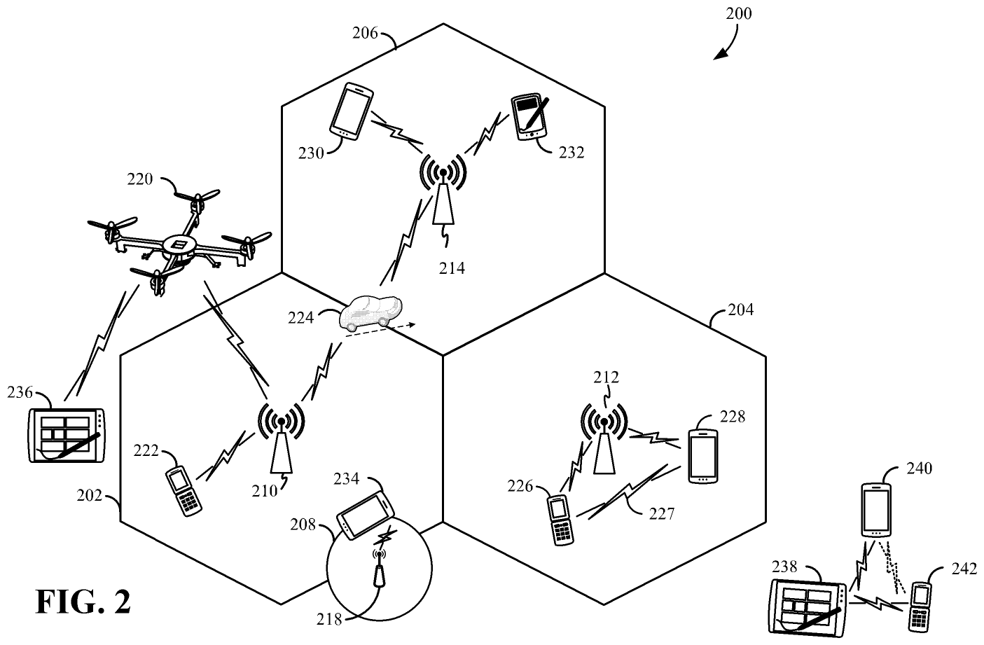

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point, base station, or network node. FIG. 2 illustrates macrocells 202, 204, and 206, and a small cell 208.

FIG. 2 shows three network nodes 210, and 212, and 214 in cells 202, 204, and 206. In the illustrated example, the cells 202, 204, and 206 may be referred to as macrocells, as the network nodes 210, 212, and 214 support cells having a large size. Further, a network node 218 is shown in the small cell 208 (e.g., a microcell, picocell, femtocell, home base station, home Node B, home eNode B, etc.) which may overlap with one or more macrocells. In this example, the cell 208 may be referred to as a small cell, as the network node 218 supports a cell having a relatively small size. Cell sizing can be done according to system design as well as component constraints.

The RAN 200 may include any number of wireless network nodes and cells. Further, a RAN may include a relay node to extend the size or coverage area of a given cell. The network nodes 210, 212, 214, 218 provide wireless access points to a core network for any number of mobile apparatuses. In some examples, the network nodes 210, 212, 214, and/or 218 may be the same as the base station/scheduling entity 108 described above and illustrated in FIG. 1.

FIG. 2 further includes a quadcopter or drone 220, which may be configured to function as a network node. That is, in some examples, a cell may not necessarily be stationary, and the geographic area of the cell may move according to the location of a mobile network node such as the quadcopter 220.

Within the RAN 200, each network node 210, 212, 214, 218, and 220 may be configured to provide an access point to a core network 102 (see FIG. 1) for all the UEs in the respective cells. For example, UEs 222 and 224 may be in communication with network node 210; UEs 226 and 228 may be in communication with network node 212; UEs 230 and 232 may be in communication with network node 214; UE 234 may be in communication with network node 218; and UE 236 may be in communication with mobile network node 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with network node 210.

In a further aspect of the RAN 200, sidelink signals may be used between UEs without necessarily relying on scheduling or control information from a network node (e.g., a scheduling entity). For example, two or more UEs (e.g., UEs 226 and 228) may communicate with each other using peer to peer (P2P) or sidelink signals 227 without relaying that communication through a network node. In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS 108 (such as a Node B (NB), evolved NB (eNB), NR BS, 5G NB, gNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

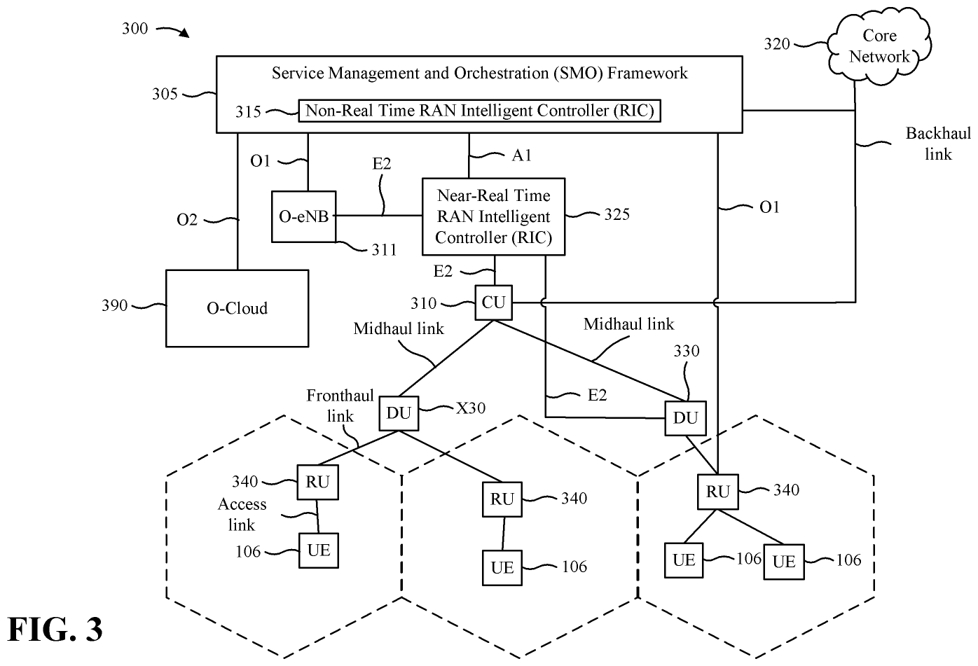

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 106 via one or more radio frequency (RF) access links. In some implementations, the UE 106 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 106. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

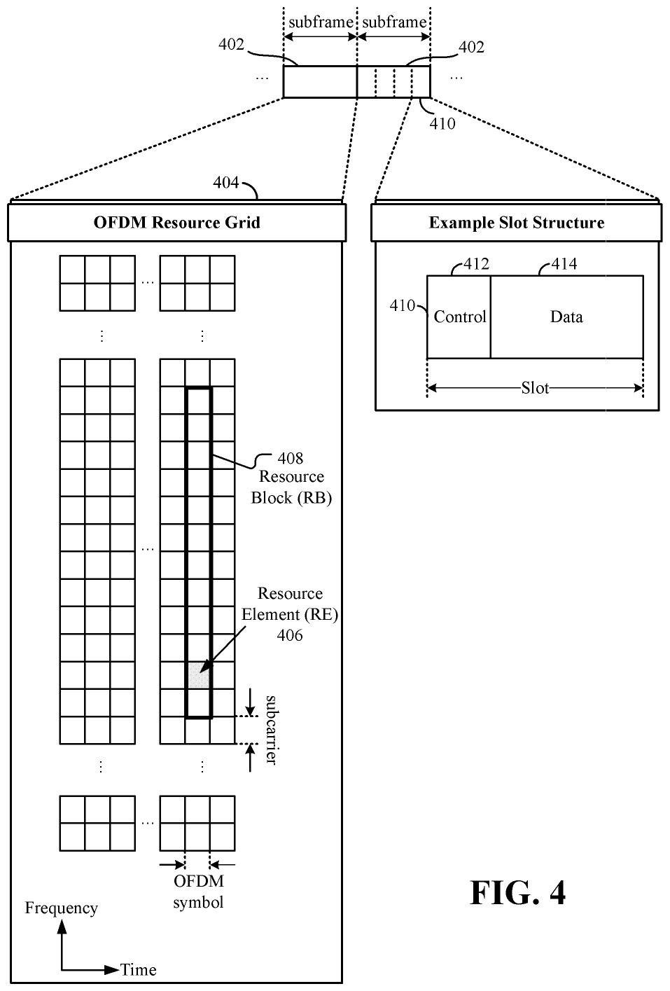

FIG. 4 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may include a set of subframes (e.g., 10 subframes of 1 ms each). A given carrier may include one set of frames in the UL, and another set of frames in the DL. FIG. 4 illustrates an expanded view of an exemplary DL subframe 402, showing an OFDM resource grid 404. However, as those skilled in the art will readily appreciate, the PHY transmission structure for any application may vary from the example described here, depending on any number of factors. Here, time is in the horizontal direction with units of OFDM symbols; and frequency is in the vertical direction with units of subcarriers or tones.

The resource grid 404 may schematically represent time-frequency resources for a given antenna port. That is, in a multiple-input multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may span 12 subcarriers, a number independent of the numerology used. In some examples, depending on the numerology, an RB may include any suitable number of consecutive OFDM symbols in the time domain.

A given UE generally utilizes only a subset of the resource grid 404. An RB may be the smallest unit of resources that a scheduler can allocate to a UE. Thus, the more RBs scheduled for a UE, and the higher the modulation scheme chosen for the air interface, the higher the data rate for the UE.

In this illustration, RB 408 occupies less than the entire bandwidth of the subframe 402, with some subcarriers illustrated above and below the RB 408. In a given implementation, subframe 402 may have a bandwidth corresponding to any number of one or more RBs 408. Further, the RB 408 is shown occupying less than the entire duration of the subframe 402, although this is merely one possible example.

Each 1 ms subframe 402 may include one or multiple adjacent slots. In FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A network node may in some cases transmit these mini-slots occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., a network node 108) may allocate one or more REs 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more UEs 106. In addition, the network node may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A network node may transmit the synchronization signals PSS and SSS (collectively referred to as SS), and in some examples, the PBCH, in an SS block that includes 4 consecutive OFDM symbols. In the frequency domain, the SS block may extend over 240 contiguous subcarriers. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a UE 106) may utilize one or more REs 406 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the network node 108 to schedule uplink transmissions. Here, in response to the SR transmitted on the UL control channel 118 (e.g., a PUCCH), the network node 108 may transmit downlink control information (DCI) 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. The RAN may provide this system information utilizing minimum system information (MSI), and other system information (OSI). The RAN may periodically broadcast the MSI over the cell to provide the most basic information a UE requires for initial cell access, and for enabling a UE to acquire any OSI that the RAN may broadcast periodically or send on-demand. In some examples, a network may provide MSI over two different downlink channels. For example, the PBCH may carry a master information block (MIB), and the PDSCH may carry a system information block type 1 (SIB1). Here, the MIB may provide a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the RAN may provide the OSI in these SIBs, e.g., SIB2 and above.

The channels or carriers described above and illustrated in FIGS. 1 and 4 are not necessarily all the channels or carriers that may be utilized between a network node 108 and UE 106, and those of ordinary skill in the art will recognize that other channels or carriers may be utilized in addition to those illustrated, such as other traffic, control, and feedback channels.

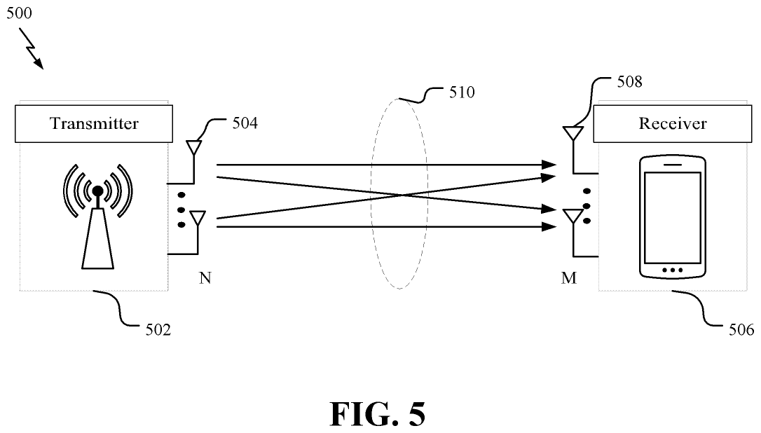

In some aspects of the disclosure, a network node and/or UE may be configured with multiple antennas for beamforming and/or multiple-input multiple-output (MIMO) technology. FIG. 5 illustrates an example of a wireless communication system 500 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 502 includes multiple transmit antennas 504 (e.g., N transmit antennas) and a receiver 506 includes multiple receive antennas 508 (e.g., M receive antennas). Thus, there are N×M signal paths 510 from the transmit antennas 504 to the receive antennas 508. Each of the transmitter 502 and the receiver 506 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 502 may send multiple data streams to a single receiver. In this way, a MIMO system takes advantage of capacity gains and/or increased data rates associated with using multiple antennas in rich scattering environments where channel variations can be tracked. Here, the receiver 506 may track these channel variations and provide corresponding feedback to the transmitter 502. In one example case, as shown in FIG. 5, a rank-2 (i.e., including 2 data streams) spatial multiplexing transmission on a 2×2 MIMO antenna configuration will transmit two data streams via two transmit antennas 504. The signal from each transmit antenna 504 reaches each receive antenna 508 along a different signal path 510. The receiver 506 may then reconstruct the data streams using the received signals from each receive antenna 508.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency and reducing the required transmission energy. This is achieved by a transmitter 502 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 506) may transmit feedback including a quantized version of the channel so that the transmitter 502 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 504 or 508, whichever is lower. In addition, the channel conditions at the receiver 506, as well as other considerations, such as the available resources at the transmitter 502, may also affect the transmission rank. For example, a network node in a RAN (e.g., transmitter 502) may assign a rank (and therefore, a number of data streams) for a DL transmission to a particular UE (e.g., receiver 506) based on a rank indicator (RI) the UE transmits to the network node. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The network node may use the RI along with resource information (e.g., the available resources and amount of data to be scheduled for the UE) to assign a DL transmission rank to the UE.

The transmitter 502 determines the precoding of the transmitted data stream or streams based, e.g., on known channel state information of the channel on which the transmitter 502 transmits the data stream(s). For example, the transmitter 502 may transmit one or more suitable reference signals (e.g., a channel state information reference signal, or CSI-RS) that the receiver 506 may measure. The receiver 506 may then report measured channel quality information (CQI) back to the transmitter 502. This CQI generally reports the current communication channel quality, and in some examples, a requested transport block size (TBS) for future transmissions to the receiver. In some examples, the receiver 506 may further report a precoding matrix indicator (PMI) to the transmitter 502. This PMI generally reports the receiver's 506 preferred precoding matrix for the transmitter 502 to use, and may be indexed to a predefined codebook. The transmitter 502 may then utilize this CQI/PMI to determine a suitable precoding matrix for transmissions to the receiver 506.

As one example, according to release-16 of 3GPP specifications for 5G NR, a RAN may employ a certain Type II precoder to a downlink transmission. For example, a release-16 Type II precoder W may be described according to the following equation.

$$W = {W}_{1} \times {\tilde{W}}_{2} \times {W}_{f}^{H} = {\sum }_{i = 0}^{2 L - 1} {\sum }_{m = 0}^{M - 1} {b}_{i} \cdot {\tilde{w}}_{i , m} \cdot {f}_{m}^{H}$$

Here, bᵢ represents a spatial domain basis vector, or the spatial domain portion of a precoder. bᵢ corresponds to the i-th column of a spatial domain basis W₁. L represents a number of spatial domain basis vectors in the spatial domain basis W₁. In some examples, the spatial domain basis W₁ may represent a singular-value decomposition (SVD) of the reciprocal (e.g., UL) channel, based on a measurement of one or more suitable reference signals such as the SRS. However, within the scope of this disclosure a spatial domain basis W₁ may be a discrete Fourier transform (DFT) basis, a Slepian basis, or any other suitable matrix that generally matches the spatial domain of the channel.

Further, fₘ^{H} represents a frequency domain basis vector. For example, fₘ^{H} may correspond to a row vector, e.g., being the m-th row of a frequency domain basis W_{f}^{H}. In various examples, W_{f}^{H} may represent a frequency domain basis of size M by N, where M is a number of frequency domain basis vectors, and N is a number of subbands (e.g., a number of columns in the frequency domain basis W_{f}^{H}). The superscript H represents a conjugate transform. While the discussion that follows assumes that the frequency domain basis vector fₘ^{H} is m-th row of W_{f}^{H}, within the scope of this disclosure, a frequency domain basis vector may generally correspond to a linear combination of a set of any suitable number of selected rows of W_{f}^{H}.

Still further, \tilde{w}_{i,m} represents a set of linear combination coefficients corresponding to UE feedback based on UE beam measurements. For example, when a UE receives a reference signal (e.g., CSI-RS) over the precoded channel (e.g., over a plurality of ports), the UE can compare the different ports with one another, e.g., in terms of received signal power. Based on these channel measurements, the UE may rank and rate the different ports, and/or may select a subset of the ports that has a relatively strong power. Thus, the UE can provide feedback to the RAN corresponding to the linear coefficients associated with the selected ports. Thus, the RAN can utilize this linear coefficient information to update a precoder for a subsequent transmission.

With this release-16 type II precoder, the UE may provide the base station with feedback from which the base station can obtain the linear combination coefficients \tilde{w}_{i,m} and the frequency domain basis vector fₘ^{H}. Thus, according to the release-16 precoder, the base station calculates the spatial domain basis vector bᵢ (e.g., based on an UL reference signal from the UE), while the UE calculates the frequency domain basis vector fₘ^{H} (e.g., based on a DL reference signal from the base station). The base station then precodes a DL transmission based on this combination of information.

Massive MIMO in particular relies on accurate channel estimation to generate a suitable precoding matrix to map a transmission signal to its antennas. However, channel estimation can face several challenges that may limit its accuracy, such as channel aging.

Channel aging can affect the accuracy of a channel estimate. That is, channel coefficients may change over time, e.g., caused by a moving user or any other reason. Therefore, at the time instant when a network node applies its estimated channel coefficients, e.g., for precoding a downlink transmission, the time instant at which the network node generated the channel coefficients has passed, potentially resulting in channel estimation error.

In particular, because massive MIMO demands significant and potentially time-consuming processing resources, the channel can experience substantial aging between the time when a network node generates a channel estimate and the time the network node uses the channel estimate for precoding. This issue is further exacerbated as modem networks use higher and higher frequencies for wireless communication (e.g., mmW). That is, at high frequencies, the coherence time, or the time interval at which the channel estimate remains substantially flat or constant, is very low.

One scheme for addressing channel aging with a low coherence time at very high frequencies is simply to generate a channel estimate more frequently. However, this approach results in increased overhead for pilot transmissions and CSI feedback, and can decrease the throughput in a cell. Another approach for addressing channel aging is to employ channel prediction, attempting to anticipate the channel aging. However, the effectiveness of previously existing channel prediction algorithms has been less than optimal.

The frequency domain basis W_{f}^{H} and spatial domain basis W₁ may be referred to as static bases, most suitable for a stationary or low-speed UE, or a relatively constant channel. According to an aspect of the present disclosure, a Doppler basis, or time-domain basis, may be employed for fast-varying channels. Furthermore, for a time-varying channel, the coefficient matrix \tilde{W}₂ varies over time. Thus, the coefficient matrix \tilde{W}₂(n) may be considered a function of time instance n.

$$W ( n ) = {W}_{1} \times {\tilde{W}}_{2} ( n ) \times {W}_{f}^{H}$$

Thus, the coefficients may be denoted as \tilde{w}_{i,m}(n).

$${\tilde{w}}_{i , m} ( n ) = {\sum }_{q = 0}^{D - 1} {d}_{q} ( n ) \cdot {γ}_{q , i , m}$$

Here, the vector d_{q}(n) represents the q-th time domain basis d_{q}=[d_{q}(0), d_{q}(1), . . . , d_{q}(N′−1)], where the length N′ of d_{q} is the furthest time instance for CSI extrapolation, as described below in connection with FIG. 4. D represents the number of time domain bases. γ_{q,i,m} is the combination coefficient for the q-th time domain basis, the i-th spatial domain basis, and the m-th frequency domain basis. Choices for the time domain basis may be DFT bases, Slepian bases, or eigenvector bases, according to some examples.

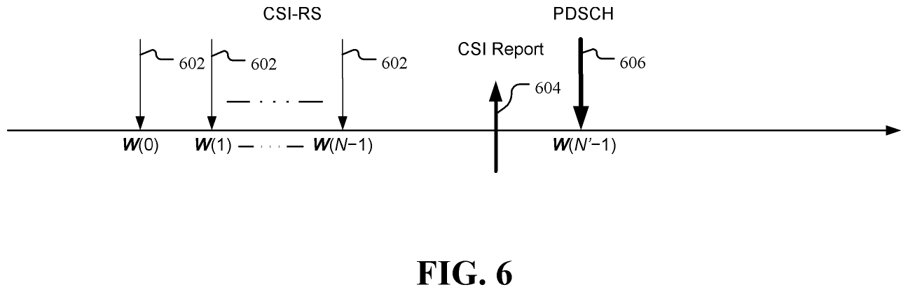

FIG. 6 is a schematic illustration of CSI extrapolation as it may be performed according to some aspects of this disclosure. In the illustrated example, a gNB transmits a set of N CSI-RS reference signals 602 for channel measurement. A UE measures the channel based on the reference signals 602 and transmits a CSI report 604. The CSI report 604 reports channel state information based on the N instances of channel measurements, from time n=0 to n=N−1. Based on the CSI report 604, the gNB estimates the precoding matrix W(\hat{n}) for times N≤\hat{n}≤N′. That is, based on the measured CSI-RSs the gNB may extrapolate the channel variations into a future time N′ when the gNB precodes a PDSCH transmission 606.

An N-point Slepian basis consists of the eigenvectors of the matrix [rᵢⱼ]_{N×N}, where the elements of the matrix are represented by the equation:

$${r}_{i j} = \frac{sin ( 2 π ( i - j ) {v}_{Dmax} )}{π ( i - j )}$$

Here, v_{Dmax} is the normalized maximum Doppler shift. To obtain the Slepian basis, a device may perform singular value decomposition (SVD) on the matrix to obtain its eigenvectors. According to some aspects of the present disclosure, a Slepian basis may be used for the time domain basis. A Slepian basis can be suitable for a flat and symmetric Doppler spectrum, but might provide less adaptability in the case of an unbalanced Doppler spectrum. That is, because the Slepian basis consists of real-valued elements, it is symmetric in the Doppler domain. However, the Doppler spectrum of the channel or the ideal precoder can be asymmetric in the Doppler domain. Accordingly, the performance of a conventional Slepian basis can be limited as a time-domain basis, as it can lead to inaccurate channel prediction. Thus, certain aspects of this disclosure provide for a modified Slepian basis suitable for an asymmetric Doppler spectrum.

For example, to accommodate an asymmetric Doppler spectrum, a modified N′-point Slepian basis may be defined by employing a multiplicative linear phase shift v_{Dshift} over time. That is, a factor v_{Dshift} may be multiplied with the q-th Slepian basis vector d_{q}=[d_{q}(0), d_{q}(1), . . . , d_{q}(N′−1)], q=0, 1, . . . , D−1, where q is an index of the specific basis among a set of D bases, to obtain a modified Slepian basis d_{q}′(n) as follows:

$${d}_{q}^{′} ( n ) = {d}_{q} ( n ) \cdot {e}^{- j 2 π {nv}_{Dshift}} , n = 0 , 1 , … , {N}^{′} - 1$$

This phase shift provides an asymmetric spectrum in the Doppler domain by multiplying the linear phase shift and shifting the Doppler spectrum by the amount v_{Dshift}. The value of v_{Dshift} can be either positive or negative. When a UE is moving forward towards a cluster (a set of reflecting objects in a multipath channel), it will have a positive v_{Dshift}; and when a UE is moving away from a cluster, it will have a negative v_{Dshift}.

According to a further aspect of this disclosure, a UE reporting a channel measurement (e.g., by transmitting a CSI report) may report one or more values of v_{Dshift}. In this way, a RAN employing a Slepian basis for the time domain basis can render a more accurate precoding matrix.

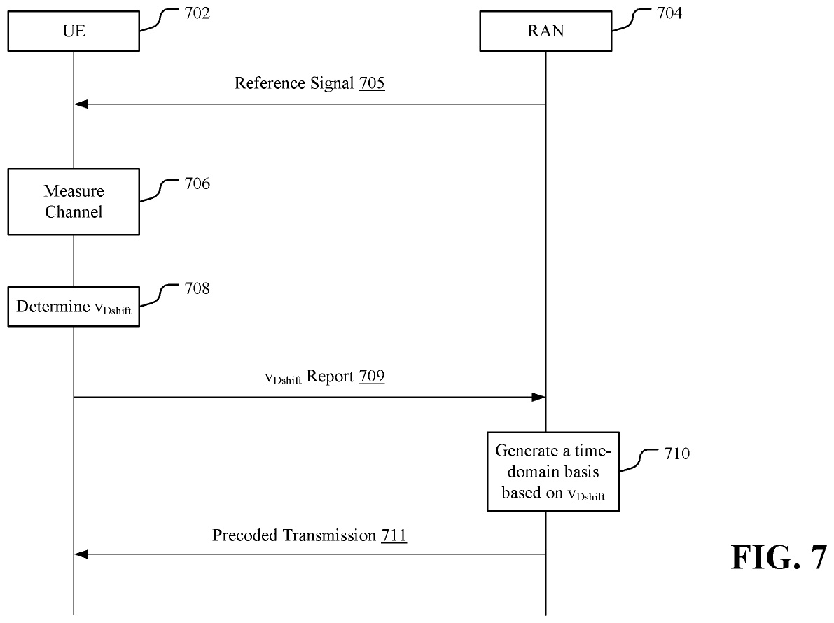

FIG. 7 is a call flow diagram illustrating a process for channel measurement and reporting according to some aspects of this disclosure. In the illustration, a UE 702 is in communication with a RAN node 704. In various examples, the UE 702 may be a UE or scheduled entity as described above and illustrated in FIGS. 1, 2, 3, and/or 5. And the RAN node 704 may be a gNB, scheduling entity, base station, or a node of a distributed gNB as described above and illustrated in FIGS. 1, 2, 3, and/or 5.

For channel characterization the RAN node 704 may transmit one or more reference signals (RSs) 705. Any suitable RS may be employed for channel characterization according to this disclosure, including but not limited to a channel state information reference signal (CSI-RS), a tracking reference signal (TRS), etc.

In some examples, the RS 705 may be configured to accommodate the generation of v_{Dshift} by the UE 702. For example, in a case where the RS 705 is a TRS, the TRS may be transmitted with higher density (e.g., shorter periodicity) than a conventional TRS. For example, the RS 705 may be a TRS transmitted with a periodicity of less than 10 ms. In another case, where the RS 705 is a CSI-RS, the CSI-RS may be transmitted with phase continuity. Here, phase continuity refers to a continuous phase in the RSs from one slot to the next. That is, for measurement of the CSI-RS, a UE may assume that a sequence of CSI-RSs has phase continuity over a plurality of slots.

At block 706, a UE may measure the channel based on the received RS 705. For example, as discussed above in connection with FIG. 6, the UE 702 may measure a set of RSs 705 and utilize this measurement to characterize the channel. At block 708, the UE may determine a value of v_{Dshift} based on the received RS 705. For example, the UE 702 may generate a Doppler spectrum based on the RS 705, and determine a time domain basis shift value based on the Doppler spectrum.

In some aspects of this disclosure, the RAN may preconfigure a UE with a fixed number of N Doppler bases. For example, the RAN node 704 may transmit suitable control signaling to the UE 702 indicating a set of N Doppler bases. Here, for a given channel measurement report the UE 702 may select a set of D (e.g., one or more) Doppler bases for each Slepian basis group.

The UE 702 may then transmit a v_{Dshift} report 709 including one or more v_{Dshift} values. For example, a UE may report one value of v_{Dshift} being associated with one group of modified Slepian bases d_{q}′. Here, the reported v_{Dshift} may correspond to the Doppler spectrum of one main cluster out of a plurality of clusters in a channel corresponding to a given beam. That is, in many scenarios one main cluster can be sufficient to determine a suitable precoder.

In another example, a UE may report a plurality of values of v_{Dshift} being associated with multiple groups of modified Slepian bases d_{q}′, d_{q}″, . . . . For example, the values of v_{Dshift} may be delay-specific corresponding to multiple clusters, where each cluster has its own Doppler spectrum. Thus, the UE may report a v_{Dshift}n per delay. That is, each phase shift value v_{Dshift} may correspond to a respective frequency domain basis of a plurality of frequency domain bases. In another example, the values of v_{Dshift} may be beam-specific corresponding to multiple directional beams. Here, some beams may have more power than others, and their respective Doppler spectra can accordingly vary. Thus, the UE may report a v_{Dshift} per beam. That is, each phase shift value v_{Dshift} may correspond to a respective spatial domain basis of a plurality of spatial domain bases.

In a further aspect, to reduce the overhead generated by transmitting the phase shift value v_{Dshift}, for either per-beam or per-delay reports of v_{Dshift}n, the UE's report may be based on the selection of non-zero coefficient (NZC) values of the coefficient matrix \tilde{W}₂ in a CSI report. For example, when a UE transmits a plurality of v_{Dshift} values on a per beam basis, the UE may report a v_{Dshift} value only for the beams (i.e., the rows in the coefficient matrix \tilde{W}₂) that contain at least one NZC. Similarly, when a UE transmits a plurality of v_{Dshift} values on a per delay basis, the UE may report a v_{Dshift} value only for the delays (i.e., the columns in the coefficient matrix \tilde{W}₂) that contain at least one NZC. In either case, because one or more rows or columns in the coefficient matrix \tilde{W}₂ may only contain zero-value coefficients, this can reduce the number of v_{Dshift} values a UE reports, reducing signaling overhead.

In a further aspect, the UE 702 may quantize the value of v_{Dshift} for reporting in the v_{Dshift} report 709. For example, the UE may select a symbol from a list or set of predetermined v_{Dshift} values to represent the v_{Dshift} for a given measurement. For example, the UE 702 may select for reporting a suitable v_{Dshift}∈{x, y, z, . . . }, where the values {x, y, z} can be predefined or configured by the RAN node 704. In another example, the UE may quantize a determined value of v_{Dshift} relative to a maximum shift value v_{Dmax}. For example, the UE 702 may select for reporting a suitable v_{Dshift}∈

$$\{ - ⌊ \frac{{ν}_{Dmax}}{2} ⌋ , - ⌊ \frac{{ν}_{Dmax}}{3} ⌋ , - ⌊ \frac{{ν}_{Dmax}}{6} ⌋ , 0 , ⌊ \frac{{v}_{Dmax}}{6} ⌋ , ⌊ \frac{{ν}_{Dmax}}{3} ⌋ , ⌊ \frac{{ν}_{Dmax}}{2} ⌋ \} ,$$

shift v_{Dmax} can be predefined or configured by the RAN node 704. In another example, the UE may determine a suitable value for v_{Dmax} based on the channel, and may report its selected v_{Dmax} to the RAN node, e.g., along with the v_{Dshift} report 709.

In some examples, the value or values of v_{Dshift} may be included in a CSI report. That is, the v_{Dshift} report 709 may be a CSI report that includes one or more v_{Dshift} values. In other examples, the one or more v_{Dshift} values may be transmitted in any suitable message, not being limited to a CSI report. In still further examples, a given transmission of one or more v_{Dshift} values may be associated with any suitable number of one or more CSI reports. That is, whether a UE reports v_{Dshift} in a CSI report or in some other message transmission, the v_{Dshift} may be associated with an effective time duration within which it can be combined with CSI reports to generate a joint spatial domain/frequency domain/time domain CSI report for the corresponding channel (or for a precoder extrapolation afterwards). Because the parameter v_{Dshift} may be a slower-varying parameter than other parameters associated with a CSI report, to reduce overhead a single v_{Dshift} report may be associated with multiple conventional CSI reports. In other words, in some aspects of this disclosure, some or even all CSI reports may omit a v_{Dshift} value. In an example where v_{Dshift} is included in a CSI report, the reported v_{Dshift} value may be combined with other parameters in one or more subsequent CSI reports that omit a v_{Dshift} value. In an example where v_{Dshift} is reported in other than in a CSI report, all CSI reports may omit a v_{Dshift} value.

At block 710, a RAN node (e.g., gNB) may employ the received phase shift value v_{Dshift} to generate a precoding matrix using a modified Slepian basis as a time domain basis. That is, the RAN node 704 may multiply the v_{Dshift} value with a group of modified Slepian bases to apply a linear phase shift to the Slepian bases. Utilizing this precoder the RAN node 704 may transmit a precoded transmission 711 to the UE 702.

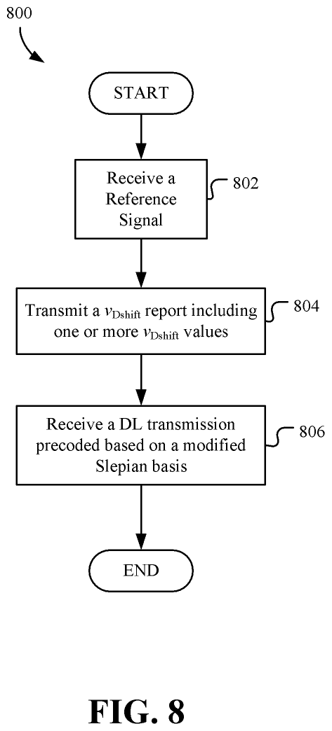

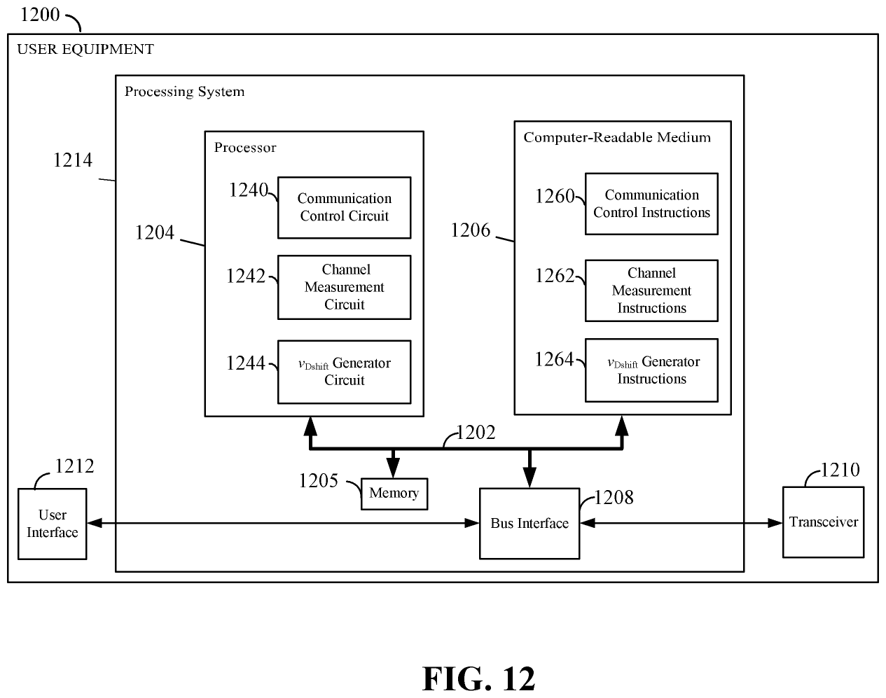

FIG. 8 is a flow chart illustrating an exemplary process 800 for employing a modified Slepian basis as a time domain basis in accordance with some aspects of the present disclosure. As described below, a particular implementation may omit some or all illustrated features, and may not require some illustrated features to implement all embodiments. In some examples, the UE 1200 illustrated in FIG. 12 may be configured to carry out the process 800. In some examples, any suitable apparatus or means for carrying out the functions or algorithm described below may carry out the process 800.

At block 802 a UE may receive a reference signal. For example, as described above, a UE may receive a CSI-RS having phase continuity, a TRS having a periodicity smaller than 10 ms, or any other suitable reference signal for generation of a v_{Dshift} value. The UE may measure the channel and accordingly generate a Doppler spectrum based on the received reference signal. In some examples, here, the UE may select a suitable Doppler spectrum based on the received reference signal, from a list of N Doppler bases configured by a gNB. Based on the generated Doppler spectrum, the UE may determine a time domain basis shift v_{Dshift} for use with a modified Slepian basis.

At block 804 the UE may transmit a v_{Dshift} report including one or more phase shift values v_{Dshift} associated with a group of modified Slepian bases. In some examples, the v_{Dshift} report may be a CSI report, although any suitable uplink message may be utilized for transmission of the v_{Dshift} value(s). In further examples, the v_{Dshift} value(s) reported at block 804 may be associated with any suitable number of one or more CSI reports. For example, a given v_{Dshift} value may be associated with an effective time duration within which it can be combined with CSI reports. The v_{Dshift} at block 804 may include any suitable number of one or more v_{Dshift} values. When the v_{Dshift} report includes multiple v_{Dshift} values, the phase shift values v_{Dshift} may be provided on a per-beam basis or a per-delay basis, as described above. Furthermore, the v_{Dshift} value(s) may be quantized by selecting a symbol from a list or set of predetermined v_{Dshift} values to represent the v_{Dshift} for a given measurement. In another example, the v_{Dshift} value(s) may be quantized as a fraction of a suitable maximum shift value v_{Dmax} as described above.

At block 806 the UE may receive a downlink transmission precoded based on a modified Slepian basis. That is, the received downlink transmission may be precoded utilizing a modified Slepian basis, shifted based on the reported v_{Dshift}, as a time domain basis.

In another aspect of this disclosure, a gNB may measure a reference signal transmitted by a UE and use this channel measurement to generate a value of v_{Dshift}. That is, rather than a UE measuring a reference signal and determining v_{Dshift} and reporting this value to the gNB, the gNB may determine the value based on an uplink reference signal.

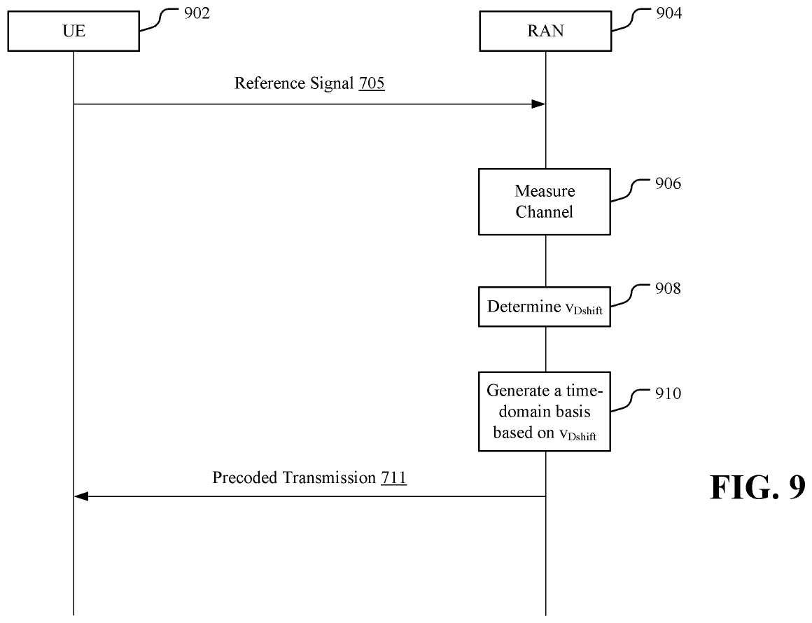

FIG. 9 is a call flow diagram illustrating a process for channel measurement and reporting according to further aspects of this disclosure. In the illustration, a UE 902 is in communication with a RAN node 904. In various examples, the UE 902 may be a UE or scheduled entity as described above and illustrated in FIGS. 1, 2, 3, and/or 5. And the RAN node 904 may be a gNB, scheduling entity, base station, or a node of a distributed gNB as described above and illustrated in FIGS. 1, 2, 3, and/or 5.

At block 906, a RAN node (e.g., gNB) may measure one or more reference signals 905 transmitted by a UE 902. For example, the UE 902 may transmit a sounding reference signal (SRS) or any other suitable uplink reference signal for gNB measurement. Similar to the UE measurement of the downlink reference signals discussed above, here, the RAN node 904 may utilize this measurement to characterize the channel and at block 908 determine a value of v_{Dshift} based on the received RS 905. For example, the RAN node 904 may generate a Doppler spectrum based on the RS 905, and determine a time domain basis shift value based on the Doppler spectrum.

At block 910, the RAN node 904 may employ the generated phase shift value v_{Dshift} to generate a precoding matrix using a modified Slepian basis as a time domain basis. That is, the RAN node may multiply the v_{Dshift} value with a group of modified Slepian bases to apply a linear phase shift to the Slepian bases. Utilizing this precoder the RAN node 904 may transmit a precoded transmission 911 to the UE 902.

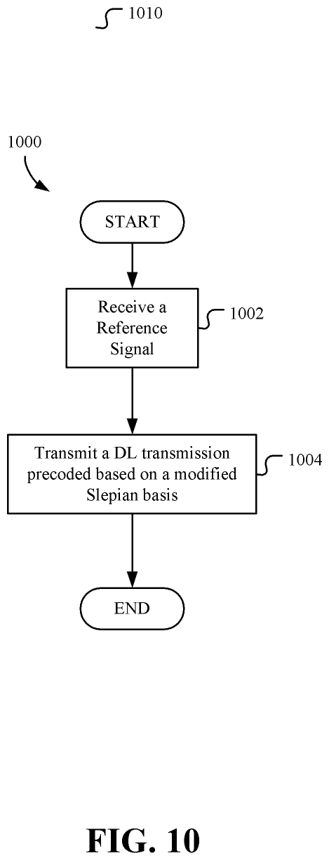

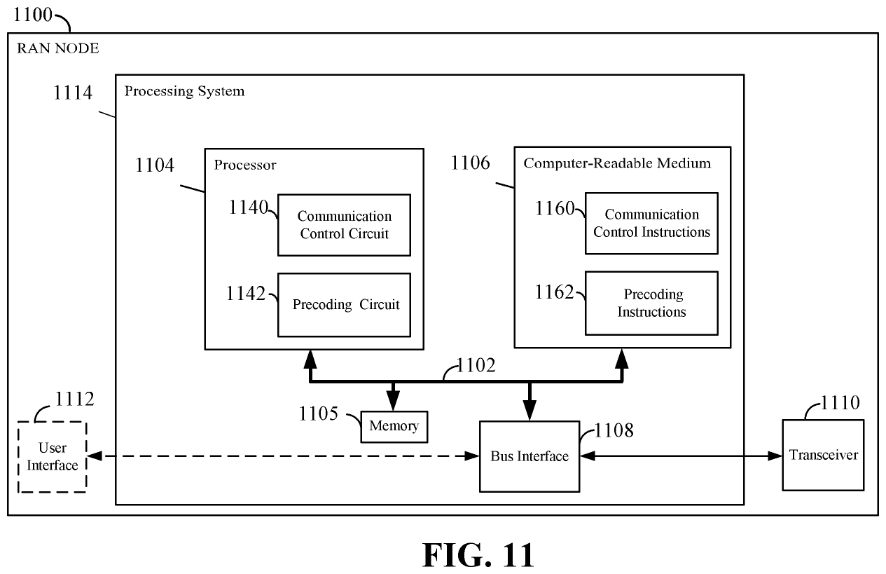

FIG. 10 is a flow chart illustrating an exemplary process 1000 for employing a modified Slepian basis as a time domain basis in accordance with some aspects of the present disclosure. As described below, a particular implementation may omit some or all illustrated features, and may not require some illustrated features to implement all embodiments. In some examples, the RAN node (e.g., a gNB) 1100 illustrated in FIG. 11 may be configured to carry out the process 1000. In some examples, any suitable apparatus or means for carrying out the functions or algorithm described below may carry out the process 1000.

At block 1002 a gNB may receive a reference signal. For example, as described above, a UE may transmit an SRS as an uplink reference signal for channel measurement by the gNB. The gNB may measure the channel and accordingly generate a Doppler spectrum based on the received reference signal. Based on the generated Doppler spectrum, the gNB may determine a time domain basis shift v_{Dshift} for use with a modified Slepian basis.

At block 1004 the gNB may transmit a downlink transmission precoded based on a modified Slepian basis. Here, the modified Slepian basis may be configured with the phase shift v_{Dshift} determined based on the uplink reference signal.

FIG. 11 is a block diagram illustrating an example of a hardware implementation for a network node 1100 employing a processing system 1114. For example, the network node 1100 may be a user equipment (ULE) as illustrated in any one or more of FIGS. 1, 2, 3, 5, 7, and/or 9. In another example, the network node 1100 may be a base station or gNB as illustrated in any one or more of FIGS. 1, 2, 3, 5, 7, and/or 9.

The network node 1100 may include a processing system 1114 having one or more processors 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network node 1100 may be configured to perform any one or more of the functions described herein. For example, the processor 1104, as utilized in a network node 1100, may be configured (e.g., in coordination with the memory 1105) to implement any one or more of the processes and procedures described above and illustrated in FIGS. 7, 9, and/or 10.

The processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits including one or more processors (represented generally by the processor 1104), a memory 1105, and computer-readable media (represented generally by the computer-readable medium 1106). The bus 1102 may also link various other circuits such as timing sources, peripherals, voltage regulators, and power management circuits, which are well known in the art, and therefore, will not be described any further. A bus interface 1108 provides an interface between the bus 1102 and a transceiver 1110. The transceiver 1110 provides a communication interface or means for communicating with various other apparatus over a transmission medium. Depending upon the nature of the apparatus, a user interface 1112 (e.g., keypad, display, speaker, microphone, joystick) may also be provided. Of course, such a user interface 1112 is optional, and some examples, such as a base station, may omit it.

In some aspects of the disclosure, the processor 1104 may include communication control circuitry 1140 configured (e.g., in coordination with the memory 1105) for various functions, including, e.g., transmitting reference signals, receiving reference signals and measuring a channel, and transmitting and receiving messages to/from one or more UEs. For example, the communication control circuitry 1140 may be configured to implement one or more of the functions described above in relation to FIG. 10, including, e.g., blocks 1002 and 1004. The processor 1104 may further include precoding circuitry 1142 configured (e.g., in coordination with the memory 1105) for various functions, including, e.g., causing transmission of a downlink transmission precoded based on a modified Slepian basis as a time domain basis. For example, the precoding circuitry 1142 may be configured to implement one or more of the functions described above in relation to FIG. 10, including, e.g., block 1004.

The processor 1104 is responsible for managing the bus 1102 and general processing, including the execution of software stored on the computer-readable medium 1106. The software, when executed by the processor 1104, causes the processing system 1114 to perform the various functions described below for any particular apparatus. The processor 1104 may also use the computer-readable medium 1106 and the memory 1105 for storing data that the processor 1104 manipulates when executing software.

One or more processors 1104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1106. The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1106 may store computer-executable code that includes communication control instructions 1160 that configure a network node 1100 for various functions, including, e.g., transmitting reference signals, receiving reference signals and measuring a channel, and transmitting and receiving messages to/from one or more UEs. For example, the communication control instructions 1160 may be configured to cause a network node 1100 to implement one or more of the functions described above in relation to FIG. 10, including, e.g., blocks 1002, and/or 1004. The computer-readable storage medium 1106 may further store computer-executable code that includes precoding instructions 1162 that configure a network node 1100 for various functions, including, e.g., causing transmission of a downlink transmission precoded based on a modified Slepian basis as a time domain basis. For example, the precoding instructions 1162 may be configured to implement one or more of the functions described above in relation to FIG. 10, including, e.g., block 1004.

In one configuration, an apparatus 1100 for wireless communication includes means for receiving a channel measurement report and/or a CSI report, means for causing transmission of a downlink transmission precoded based on a modified Slepian basis as a time domain basis, means for receiving an uplink reference signal, means for generating a phase shift v_{Dshift} based on the uplink reference signal, and means for causing transmission of a CSI-RS and/or TRS. In one aspect, the aforementioned means may be the processor 1104 shown in FIG. 11 configured to perform the functions recited by the aforementioned means. In another aspect, the aforementioned means may be a circuit or any apparatus configured to perform the functions recited by the aforementioned means.

Of course, in the above examples, the circuitry included in the processor 1104 is merely provided as an example, and other means for carrying out the described functions may be included within various aspects of the present disclosure, including but not limited to the instructions stored in the computer-readable storage medium 1106, or any other suitable apparatus or means described in any one of the FIGS. 1, 2, 3, and/or 5, and utilizing, for example, the processes and/or algorithms described herein in relation to FIGS. 7, 9, and/or 10.

FIG. 12 is a conceptual diagram illustrating an example of a hardware implementation for an exemplary scheduled entity 1200 employing a processing system 1214. In accordance with various aspects of the disclosure, a processing system 1214 may include an element, or any portion of an element, or any combination of elements having one or more processors 1204. For example, the scheduled entity 1200 may be a user equipment (UE) as illustrated in any one or more of FIGS. 1, 2, 3, 5, 7, and/or 9.

The processing system 1214 may be substantially the same as the processing system 1114 illustrated in FIG. 11, including a bus interface 1208, a bus 1202, memory 1205, a processor 1204, and a computer-readable medium 1206. Furthermore, the UE 1200 may include a user interface 1212 and a transceiver 1210 substantially similar to those described above in FIG. 11. That is, the processor 1204, as utilized in a UE 1200, may be configured (e.g., in coordination with the memory 1205) to implement any one or more of the processes described above and illustrated in FIGS. 7, 8, and/or 9.

In some aspects of the disclosure, the processor 1204 may include communication control circuitry 1240 configured (e.g., in coordination with the memory 1205) for various functions, including, e.g., transmitting and receiving a reference signal, and transmitting and receiving messages such as channel measurement reports. For example, the communication control circuitry 1240 may be configured to implement one or more of the functions described above in relation to FIG. 8, including, e.g., blocks 802, 804, and/or 806. The processor 1204 may further include channel measurement circuitry 1242 configured (e.g., in coordination with the memory 1205) for various functions, including, e.g., measuring a channel based on one or more reference signals. The processor 1204 may further include v_{Dshift} generator circuitry configured (e.g., in coordination with the memory 1205) for various functions, including, e.g., generating a phase shift value v_{Dshift} associated with a group of modified Slepian bases, based on a channel measurement by channel measurement circuitry 1242.

And further, the computer-readable storage medium 1206 may store computer-executable code that includes communication control instructions 1260 that configure a UE 1200 for various functions, including, e.g., transmitting and receiving a reference signal, and transmitting and receiving messages such as channel measurement reports. For example, the communication control instructions 1260 may be configured to cause a UE 1200 to implement one or more of the functions described above in relation to FIG. 8, including, e.g., blocks 802, 804, and/or 806. The computer-readable storage medium 1206 may further store computer-executable code that includes channel measurement instructions 1262 configured for various functions, including, e.g., measuring a channel based on one or more reference signals. The computer-readable storage medium 1206 may further store computer-executable code that includes v_{Dshift} generator instructions configured for various functions, including, e.g., generating a phase shift value v_{Dshift} associated with a group of modified Slepian bases, based on a channel measurement by channel measurement circuitry 1242 and/or channel measurement instructions 1262.

In one configuration, an apparatus 1200 for wireless communication includes means for receiving reference signals and other messages, means for transmitting reference signals and other messages, means for measuring a channel based on a reference signal, and means for generating a phase shift value v_{Dshift}. In one aspect, the aforementioned means may be the processor(s) 1204 shown in 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 3, and/or 5, and utilizing, for example, the processes and/or algorithms described herein in relation to FIGS. 7, 8, 9, and/or 10.

### Further Examples Having a Variety of Features

Example 1: A method, apparatus, and non-transitory computer-readable medium for wireless communication includes receiving a reference signal, and transmitting a phase shift value v_{Dshift} based on the reference signal. The phase shift value v_{Dshift} is associated with a group of modified Slepian bases. Further, a downlink transmission precoded based on a modified Slepian basis as a time domain basis is received.

Example 2: A method, apparatus, and non-transitory computer-readable medium of Example 1, wherein the reference signal is a channel state information reference signal (CSI-RS) configured with phase continuity across a plurality of slots.

Example 3: A method, apparatus, and non-transitory computer-readable medium of Example 1, wherein the reference signal is a tracking reference signal (TRS) configured with a periodicity of less than 10 ms.

Example 4: A method, apparatus, and non-transitory computer-readable medium of any of Examples 1 to 3, further including transmitting a plurality of channel state information reports (CSI reports) each associated with the phase shift value v_{Dshift}.

Example 5: A method, apparatus, and non-transitory computer-readable medium of any of examples 1 to 4, wherein the phase shift value v_{Dshift} is one of a plurality of phase shift values associated with a plurality of groups of modified Slepian bases.

Example 6: A method, apparatus, and non-transitory computer-readable medium of any of examples 1 to 5, wherein each phase shift value v_{Dshift} of the plurality of phase shift values corresponds to a respective frequency domain basis of a plurality of frequency domain bases.

Example 7: A method, apparatus, and non-transitory computer-readable medium of any of examples 1 to 6, wherein each phase shift value v_{Dshift} of the plurality of phase shift values corresponds to a respective column in a coefficient matrix that contains at least one non-zero coefficient.

Example 8: A method, apparatus, and non-transitory computer-readable medium of any of examples 1 to 5, wherein each phase shift value v_{Dshift} of the plurality of phase shift values corresponds to a respective spatial domain basis of a plurality of spatial domain bases.

Example 9: A method, apparatus, and non-transitory computer-readable medium of any of examples 1 to 5 or 8, wherein each phase shift value v_{Dshift} of the plurality of phase shift values corresponds to a respective row in a coefficient matrix that contains at least one non-zero coefficient.

Example 10: A method, apparatus, and non-transitory computer-readable medium of any of examples 1 to 9, further including selecting the phase shift value v_{Dshift} from a list of predetermined phase shift values.

Example 11: A method, apparatus, and non-transitory computer-readable medium of Example 10, wherein the list of predetermined phase shift values are respective portions of a maximum shift value v_{Dmax}.

Example 12: A method, apparatus, and non-transitory computer-readable medium for wireless communication includes receiving a phase shift value v_{Dshift} associated with a group of modified Slepian bases, and causing transmission of a downlink transmission precoded based on a modified Slepian basis as a time domain basis.

Example 13: A method, apparatus, and non-transitory computer-readable medium of Example 12, further including transmitting a channel state information reference signal (CSI-RS) configured with phase continuity across a plurality of slots, wherein the phase shift value v_{Dshift} corresponds to a measurement of the CSI-RS.

Example 14: A method, apparatus, and non-transitory computer-readable medium of Example 12, further including transmitting a tracking reference signal (TRS) configured with a periodicity of less than 10 ms, wherein the phase shift value v_{Dshift} corresponds to a measurement of the TRS.

Example 15: A method, apparatus, and non-transitory computer-readable medium of any of Examples 12 to 14, further including receiving a plurality of channel state information reports (CSI reports) each associated with the phase shift value v_{Dshift}.

Example 16: A method, apparatus, and non-transitory computer-readable medium of any of Examples 12 to 15, wherein the phase shift value v_{Dshift} is one of a plurality of phase shift values associated with a plurality of groups of modified Slepian bases.

Example 17: A method, apparatus, and non-transitory computer-readable medium of any of Examples 12 to 16, wherein each phase shift value v_{Dshift} of the plurality of phase shift values corresponds to a respective frequency domain basis of a plurality of frequency domain bases.

Example 18: A method, apparatus, and non-transitory computer-readable medium of any of Examples 12 to 17, wherein each phase shift value v_{Dshift} of the plurality of phase shift values corresponds to a respective column in a coefficient matrix that contains at least one non-zero coefficient.

Example 19: A method, apparatus, and non-transitory computer-readable medium of any of Examples 12 to 16, wherein each phase shift value v_{Dshift} of the plurality of phase shift values corresponds to a respective spatial domain basis of a plurality of spatial domain bases.

Example 20: A method, apparatus, and non-transitory computer-readable medium of any of Examples 12 to 16 or 19, wherein each phase shift value v_{Dshift} of the plurality of phase shift values corresponds to a respective row in a coefficient matrix that contains at least one non-zero coefficient.

Example 21: A method, apparatus, and non-transitory computer-readable medium for wireless communication includes receiving an uplink reference signal, and transmitting a downlink transmission precoded based on a modified Slepian basis as a time domain basis. Here, the modified Slepian basis is configured with a phase shift v_{Dshift} determined based on the uplink reference signal.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus for wireless communication, comprising:
a memory; and
a processor coupled to the memory and configured to:
receive, via a transceiver coupled to the processor, a reference signal;
transmit, via the transceiver, a phase shift value v_{Dshift} based on the reference signal, the phase shift value v_{Dshift} associated with a group of modified Slepian bases; and
receive, via the transceiver, a downlink transmission precoded based on a modified Slepian basis as a time domain basis.

2. The apparatus of claim 1, wherein the reference signal is a channel state information reference signal (CSI-RS) configured with phase continuity across a plurality of slots.

3. The apparatus of claim 1, wherein the reference signal is a tracking reference signal (TRS) configured with a periodicity of less than 10 ms.

4. The apparatus of claim 1, wherein the processor is further configured to:
transmit, via the transceiver, a plurality of channel state information reports (CSI reports) each associated with the phase shift value v_{Dshift}.

5. The apparatus of claim 1, wherein the phase shift value v_{Dshift} is one of a plurality of phase shift values associated with a plurality of groups of modified Slepian bases.

6. The apparatus of claim 5, wherein each phase shift value v_{Dshift} of the plurality of phase shift values corresponds to a respective frequency domain basis of a plurality of frequency domain bases.

7. The apparatus of claim 6, wherein each phase shift value v_{Dshift} of the plurality of phase shift values corresponds to a respective column in a coefficient matrix that contains at least one non-zero coefficient.

8. The apparatus of claim 5, wherein each phase shift value v_{Dshift} of the plurality of phase shift values corresponds to a respective spatial domain basis of a plurality of spatial domain bases.

9. The apparatus of claim 8, wherein each phase shift value v_{Dshift} of the plurality of phase shift values corresponds to a respective row in a coefficient matrix that contains at least one non-zero coefficient.

10. The apparatus of claim 1, wherein the processor is further configured to select the phase shift value v_{Dshift} from a list of predetermined phase shift values.

11. The apparatus of claim 10, wherein the list of predetermined phase shift values are respective portions of a maximum shift value v_{Dmax}.

12. An apparatus for wireless communication, comprising:
a memory; and
a processor coupled to the memory and configured to:
receive a phase shift value v_{Dshift} associated with a group of modified Slepian bases; and
cause transmission of a downlink transmission precoded based on a modified Slepian basis as a time domain basis.

13. The apparatus of claim 12, wherein the processor is further configured to:
cause transmission of a channel state information reference signal (CSI-RS) configured with phase continuity across a plurality of slots,
wherein the phase shift value v_{Dshift} corresponds to a measurement of the CSI-RS.

14. The apparatus of claim 12, wherein the processor is further configured to:
cause transmission of a tracking reference signal (TRS) configured with a periodicity of less than 10 ms,
wherein the phase shift value v_{Dshift} corresponds to a measurement of the TRS.

15. The apparatus of claim 12, wherein the processor is further configured to:
receive a plurality of channel state information reports (CSI reports) each associated with the phase shift value v_{Dshift}.

16. The apparatus of claim 12, wherein the phase shift value v_{Dshift} is one of a plurality of phase shift values associated with a plurality of groups of modified Slepian bases.

17. The apparatus of claim 16, wherein each phase shift value v_{Dshift} of the plurality of phase shift values corresponds to a respective frequency domain basis of a plurality of frequency domain bases.

18. The apparatus of claim 17, wherein each phase shift value v_{Dshift} of the plurality of phase shift values corresponds to a respective column in a coefficient matrix that contains at least one non-zero coefficient.

19. The apparatus of claim 16, wherein each phase shift value v_{Dshift} of the plurality of phase shift values corresponds to a respective spatial domain basis of a plurality of spatial domain bases.

20. The apparatus of claim 19, wherein each phase shift value v_{Dshift} of the plurality of phase shift values corresponds to a respective row in a coefficient matrix that contains at least one non-zero coefficient.

21. An apparatus for wireless communication, comprising:
a memory; and
a processor coupled to the memory and configured to:
receive, via a transceiver coupled to the processor, an uplink reference signal; and
transmit, via the transceiver, a downlink transmission precoded based on a modified Slepian basis as a time domain basis,
wherein the modified Slepian basis is configured with a phase shift v_{Dshift} determined based on the uplink reference signal.

22. A method of wireless communication, comprising:
receiving a reference signal;
transmitting a phase shift value v_{Dshift} based on the reference signal, the phase shift value v_{Dshift} associated with a group of modified Slepian bases; and
receiving a downlink transmission precoded based on a modified Slepian basis as a time domain basis.

23. The method of claim 22, wherein the reference signal is one of:
a channel state information reference signal (CSI-RS) configured with phase continuity across a plurality of slots; or
a tracking reference signal (TRS) configured with a periodicity of less than 10 ms.

24. The method of claim 22, further comprising:
transmitting a plurality of channel state information reports (CSI reports) each associated with the phase shift value v_{Dshift}.

25. The method of claim 22, wherein the phase shift value v_{Dshift} is one of a plurality of phase shift values associated with a plurality of groups of modified Slepian bases.

26. The method of claim 25, wherein each phase shift value v_{Dshift} of the plurality of phase shift values corresponds to a respective frequency domain basis of a plurality of frequency domain bases.

27. The method of claim 26, wherein each phase shift value v_{Dshift} of the plurality of phase shift values corresponds to a respective column in a coefficient matrix that contains at least one non-zero coefficient.

28. The method of claim 25, wherein each phase shift value v_{Dshift} of the plurality of phase shift values corresponds to a respective spatial domain basis of a plurality of spatial domain bases.

29. The method of claim 28, wherein each phase shift value v_{Dshift} of the plurality of phase shift values corresponds to a respective row in a coefficient matrix that contains at least one non-zero coefficient.

30. The method of claim 22, further comprising selecting the phase shift value v_{Dshift} from a list of predetermined phase shift values.
